(19) United States
(12) Patent Application Publication
(10) Pub. No.: US 2017/0370043 A1
(43) Pub. Date: Dec. 28, 2017

(54) CLOTHES DRYING STAND

(71) Applicant: William A. Rigsby, Dubois, WY (US)

(72) Inventor: William A. Rigsby, Dubois, WY (US)

(21) Appl. No.: 15/590,992

(22) Filed: May 9, 2017

Related U.S. Application Data
(60) Provisional application No. 62/334,018, filed on May 10, 2016.

(51) Int. Cl. D06F 59/04; A47L 23/20; D06F 57/12; D06F 58/10; F26B 21/00; F26B 25/18

(52) U.S. Cl. CPC D06F 59/04; D06F 58/10; F26B 21/008; A47L 23/205; D06F 57/12; F26B 25/18

(57) ABSTRACT

An improved drying stand is provided for drying clothing articles over a source of hot air. The drying stand includes a housing, which has a base with a plurality of holes in connection with the source of hot air, and sidewalls, defining a chamber. Conduits are connected to the openings in the base. The conduits may include a cap connected to the end, such that hot air flows through the openings in the base, through the conduits, and then is directed outwardly by the caps. The caps may serve both to direct hot air outwardly and to prevent any debris, such as dirty water, mud, dirt, etc. from falling out of the chamber through the conduits. In this manner, the drying stand provides a place for the clothing articles to dry and keeps the surrounding surfaces clean.

### BACKGROUND OF THE INVENTION

### 1. The Field of the Invention

The present invention relates to a device for drying clothes, more specifically, to a stand to be used to dry clothes and contain dirt.

### 2. State of the Art

Muddy and wet clothes and footwear are typical due to a variety of situations, such as work or play in the rain or snow, as well as working around water. It is often inconvenient to dry the clothing. While a clothes dryer may be used, wet clothing is often muddy and it is undesirable to place the article in the dryer, as doing so will risk leaving dirt inside the dryer to later soil clean clothing that is placed in it. Often, the wet clothing or footwear article is simply left in a garage or in a mud room to allow it to dry. Doing so, however, results in the article being unavailable for wear for many hours or even days. It may even result in the article developing mildew and/or mold if it does not fully dry or dries too slowly.

One common solution is to place clothing on a drying rack, such as a rack that positions the clothing surfaces, both internal and external, so that they may be dried by air. These types of racks may also be positioned on or near a typical home heating vent to speed up the drying process (see, for example, U.S. Pat. No. 5,394,619). However, as the dirty clothing dries, it is common for it to drip dirty water, mud, and/or dried dirt onto the surrounding surfaces. Thus, many drying devices may allow dirt and mud, as it dries, to fall onto the surrounding floor and/or fall into a vent over which the drying stand is placed.

Accordingly, there is a need for an improved drying device that allows dirty, wet and/or muddy clothing to be dried while also securely containing any mess that may incur from dirt and/or mud falling off the clothing as it dries.

### SUMMARY

A clothing drying stand is provided which may be used in combination with a conventional floor register, the drying stand comprising a housing having a base and sidewalls, defining a chamber to hold articles to be dried.

According to one aspect, the base may be provided with a plurality of openings that are in connection with a source of hot air. The openings may be provided with vertically extending hollow conduits, and the hollow conduits may include caps. In some configurations, a drying stand may be provided with conduits that are varying shapes and sizes which may be configured to support clothing articles and footwear of different shapes and sizes.

According to another aspect, the caps on the conduits may direct airflow from the caps outwardly to dry clothing, and the caps may also prevent dirt, mud, etc., from falling through the conduits onto the surrounding floor and/or vent.

According to another aspect, the housing is substantially enclosed on the bottom such that air may flow in through the plurality of openings, but dirt, mud, etc. may not fall out of the housing. Thus, substantially all of the dirt, mud, water, etc. may be trapped and contained within the chamber of the housing, preventing messes on the surrounding area and/or vent.

According to another aspect, the drying stand may be sized so that it may be placed over a standard floor register cover of a forced hot air heating system. In other configurations, the drying stand may be sized to fit within a duct of a forced hot air heating system when the register is removed.

These and other aspects of the present invention are realized in a clothing drying stand and method of use as shown and described in the following figures and related description. It will be appreciated that various configurations of the invention may not include each aspect set forth above and aspects discussed above shall not be read into the claims unless specifically described therein.

### BRIEF DESCRIPTION OF THE DRAWINGS

Various configurations of the present invention are shown and described in reference to the numbered drawings wherein:

FIG. 1 shows a partial cut-away perspective view of one configuration of a clothing drying stand;

FIG. 2 shows a side, cut-away view of the clothing drying stand of FIG. 1;

FIG. 3 shows a bottom view of the clothing drying stand of FIG. 1;

FIG. 4 shows a top view of the clothing drying stand of FIG. 1;

FIG. 5 shows a side view of a conduit and cap as described herein;

FIG. 6 shows a side, cut-away view of a clothing drying stand with articles of clothing placed thereon for drying;

FIG. 7 shows an alternate configuration of a drying stand and conduits which may be used in the drying stand;

FIG. 8 shows an alternate configuration of a clothing drying stand;

FIG. 9 shows an alternate configuration of a clothes drying stand; and

FIG. 9A shows an end view of the cap and a conduit of FIG. 9.

It will be appreciated that the drawings are illustrative and not limiting of the scope of the invention which is defined by the appended claims. The configurations shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every configuration need accomplish all advantages of the present invention.

### DETAILED DESCRIPTION

The invention and accompanying drawings will now be discussed in reference to the numerals provided therein so as to enable one skilled in the art to practice the present invention. The skilled artisan will understand, however, that the clothes drying stand, method of manufacture, and method of use described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one configuration” or “a configuration” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” in various places may not necessarily limit the inclusion of a particular element of the invention to a single configuration, rather the element may be included in other or all configurations discussed herein.

Furthermore, the described features, structures, or characteristics of configurations of the invention may be combined in any suitable manner in one or more configurations. In the following description, numerous specific details are provided, such as examples of products or manufacturing techniques that may be used, to provide a thorough understanding of configurations of the clothing drying stand disclosed herein. One skilled in the relevant art will recognize, however, that configurations of the clothing drying stand may be practiced without one or more of the specific details, or with other methods, components, materials, and so forth. In other instances, well-known structures, materials, or operations are not shown or described in detail to avoid obscuring aspects of the invention.

Before the present invention is disclosed and described in detail, it should be understood that the present disclosure is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or configurations shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “an opening” may include one or more of such opening, and reference to “a layer” may include reference to one or more of such layers.

As used herein, the term “substantially” refers to the complete or nearly complete extent or degree of an action, characteristic, property, state, structure, item, or result to function as indicated. For example, an object, such as a cap connected to a conduit, that is connected such that a “substantially” open space is created would mean that the space between the cap and the conduit is either completely open or nearly completely open. The exact allowable degree of deviation from absolute openness may in some cases depend on the specific context. The use of “substantially” is equally applicable when used in a negative connotation to refer to the complete or near complete lack of an action, characteristic, property, state, structure, item, or result. For example, structure which is “substantially free of” any openings for dirt to escape would either completely lack any openings for dirt to escape or so nearly completely lack any openings for dirt to escape that the effect would be effectively the same as if it lacked any holes for dirt to escape.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

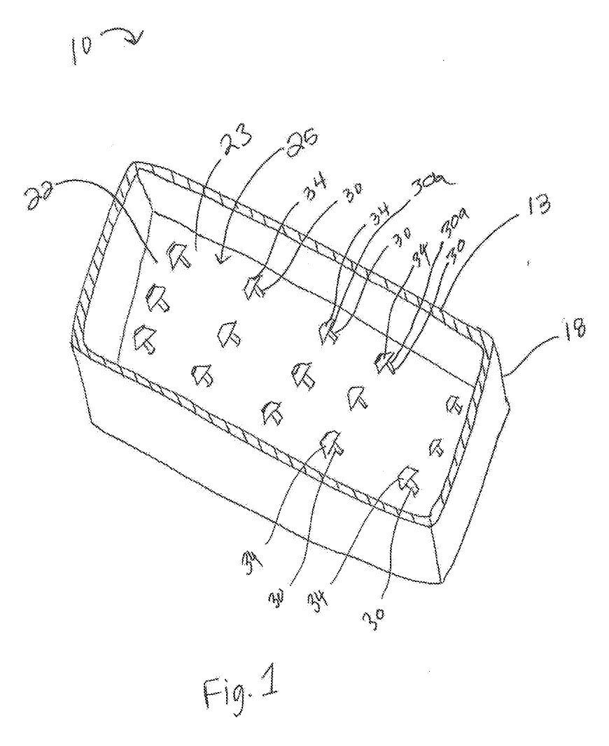

Turning now to FIG. 1, a partial cut-away perspective view of a clothes drying stand, generally indicated at 10, is shown. The drying stand 10 may include a housing 13, formed by a housing outer wall 18 (which is partially cut-away so the base can be viewed) and an interior base 22, so as to form an upper chamber 25 into which clothing articles, footwear, and the like may be placed to dry. The base 22 may be formed by a wall 23 which includes a plurality of holes or openings 28 (not visible in FIG. 1) A plurality of conduits 30 extend upwardly from the openings to channel heated air into the upper chamber 25 in a manner that will be discussed in additional detail below.

As shown in FIG. 1, the conduits 30 have a covered upper end 30a so as to prevent water, dirt or the like from falling through the conduits. The upper ends 30a may be covered, for example with a cap 34 which deflects falling water or dirt away from the opening(s) in the conduit.

The drying stand 10 may be configured to fit over a conventional heating register, such that hot air exiting the register comes up through the plurality of holes 28 in the base 22, through conduits 30, and is directed outwardly by the caps 34, which are described in more detail below. As such the upper chamber 25 is filled with heated air, which dries materials disposed in the upper chamber. Water and mud/dirt falling from the items being dried collects on the wall 23 of the base 22, but does not enter the conduits because of the height—typically 0.5 inches or taller.

The drying stand 10 may be designed to rest over the register of a floor duct that delivers hot air from a forced hot air heating system. In other configurations, the drying stand 10 may be dimensioned to fit within a hot air duct when the register is removed.

The conduits 30 as shown in FIG. 1 may be hollow cylinders. However, the conduits 30 may also be any other suitable shape, and any hollow object that may be used to direct air flow is contemplated herein. The conduit 30 may be open at the top and the bottom, such that air may flow freely through the conduit and be directed thereby. A conduit 30 may direct airflow, and may also provide conduit for articles to be dried.

The caps 34 may be attached to the end of each conduit, or may be supported by some other structure, such as legs reaching down to the base wall 23 at the bottom of the upper chamber. The cap 34 may serve to direct air flow outwardly and into articles of clothing and footwear to be dried. (Articles of clothing and footwear may be placed generally within the chamber 25 of the drying device, or a specific article may be placed directly over one or more conduits 30 such that airflow is directed to the inside surface of the article of clothing or footwear—or may simply be placed in the upper chamber on top of the conduits.) The cap 34 may also serve to prevent dirty water, mud, and/or dried dirt from falling through the hollow conduit 30 and onto the ground or into an air duct.

While it is anticipated that the drying stand 10 will commonly be used with gloves and shoes/boots, it will be appreciated that it can also be used with a variety of items which may have become wet or muddy. For example, a wet jacket, shirt, pants, scarf or blanket may be simply tossed into the upper chamber 25 where it will be dried by warm air passing through the conduits 30.

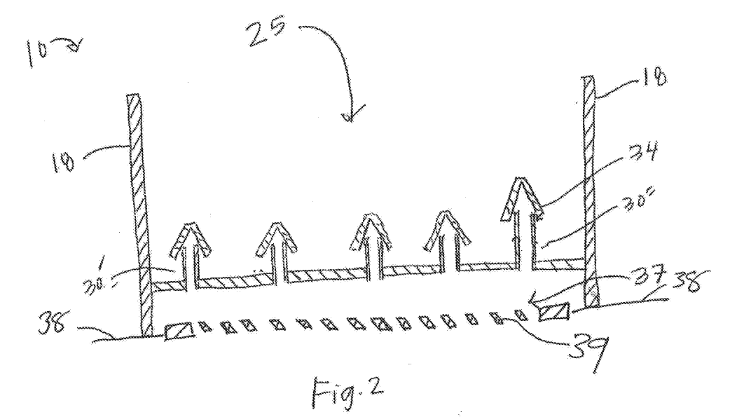

Turning now to FIG. 2, there is shown a side, cut-away view of the drying stand 10. As can be seen, the outer wall 18 of the housing 13 may extend below the base 22 so as to form an air gap or lower chamber 37 below the base. In this manner, the lower end of the outer wall 18 may contact the floor 38 around a heat register 39 and direct warm air coming out of the register through the conduits 30. Thus, if the drying stand 10 is placed over a heat register, the air may flow into the air gap 37, and then be directed up into the chamber 25 of the housing, through the openings 28 in the base 22 and conduits 30, and be directed outwardly by caps 34. As can be seen in FIG. 2, the conduits 30 may be of different heights, such as a shorter conduit 30′ (e.g. 0.5 inches) and a taller conduit 30″ (e.g. 1 inch or 2 inches). It will also be appreciated that drying stands may be sized with taller or shorter conduits based on the likely level of mud or water the user anticipates having. For example a typical home model may only have conduits which are 0.5 or 1 inch high, while a heavy-duty model may have conduits which are 2 inches high.

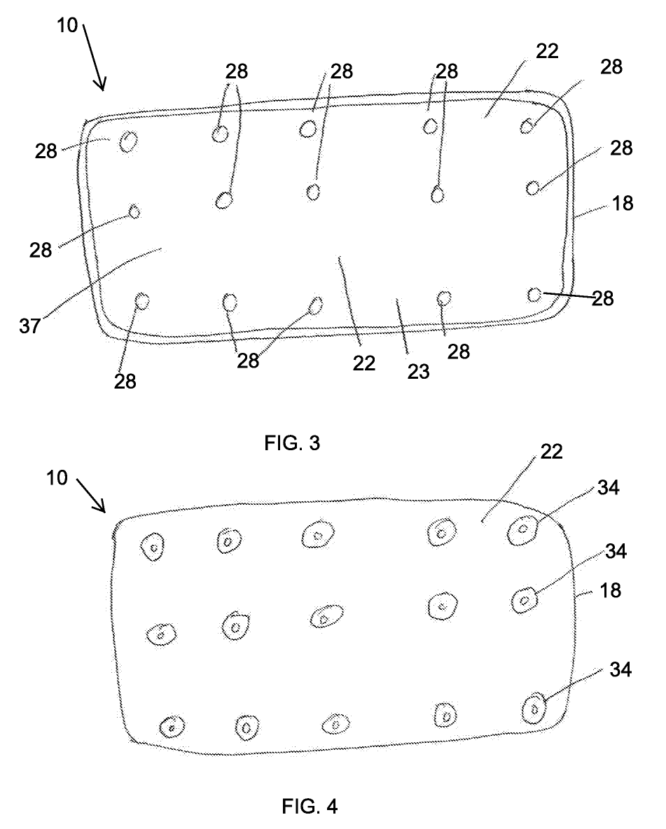

Turning now to FIG. 3, there is shown a bottom view of the drying stand 10. As can be seen in this view, the base 22 of the housing comprises a plurality of openings 28 or holes. Openings 28 may vary in size, number, and placement depending on the desired configuration. By way of example, as shown in FIG. 3, the openings 28 may be spaced equally or approximately equally apart. It will be appreciated that smaller openings may constrict air flow more than larger openings. In other configurations, openings of various sizes may be provided, such as some smaller openings and some larger openings, etc.

Turning now to FIG. 4, there is shown a top view of the drying stand 10. The top side of the base 22 may include a plurality of conduits 30 (not visible in FIG. 4) connected to the plurality of openings 28. The conduits 30 may have a cap 34 placed on the end thereof. The cap 34 may be used to direct the hot air from the conduit outwardly. Additionally, the cap 34 may prevent dirty water, mud, dried dirt, etc. from falling through the conduits 30 and openings 28 into a floor vent or onto the floor. In this manner, the caps 34 may keep dirt, mud, etc. trapped substantially in the chamber 25. The chamber 25 is substantially enclosed such that hot air may enter through the plurality of openings, but mud, dirt, water, etc. may not escape.

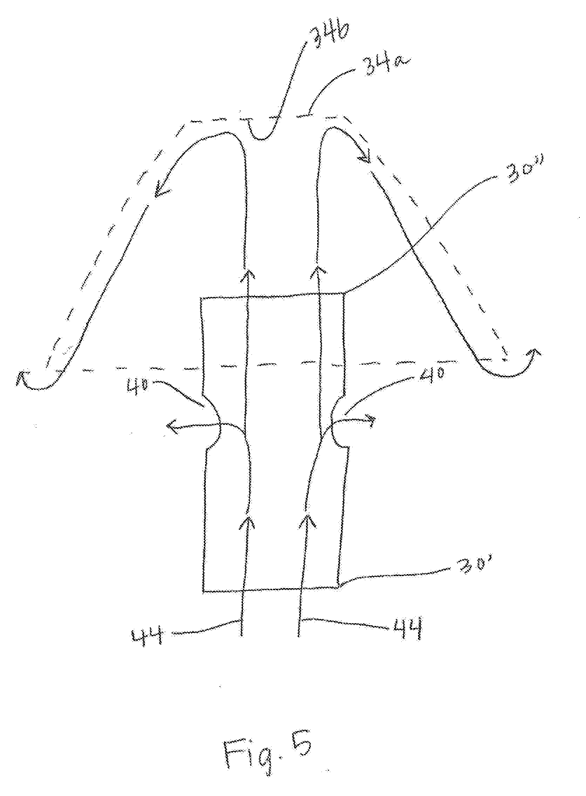

Turning now to FIG. 5, there is shown a side view of a conduit 30 with a cap 34, the cap 34 shown in dashed lines. As can be seen, the conduit may have two open ends, a first end 30a and a second end 30b′. The first, upper end 30a may be open, and the second, lower end 30b that may be connected to or formed integrally with one of the plurality of openings 28 in the base 22.

In FIG. 5, the cap is shown as having a flat top and extending downwardly and outwardly, i.e. an inverted frusto-conical shape with an extension or arm attaching the cap to the conduit 30. The caps 34 may be a variety of other shapes as well shapes. For example, the caps may be an inverted V-shape, with one or both sides attached to the conduit. Likewise, the caps may be mushroom shaped, a flat disk, hemispherical, etc., so that water and mud may either land on directly on the base 22 of the housing 13 and be contained, or it may land on the upper side 34a of cap 34 and be directed away from the conduit. Either way, the dirt, mud, etc. may be substantially contained within the chamber 25 of the housing 13, preventing messes on the surrounding area and/or heating vent.

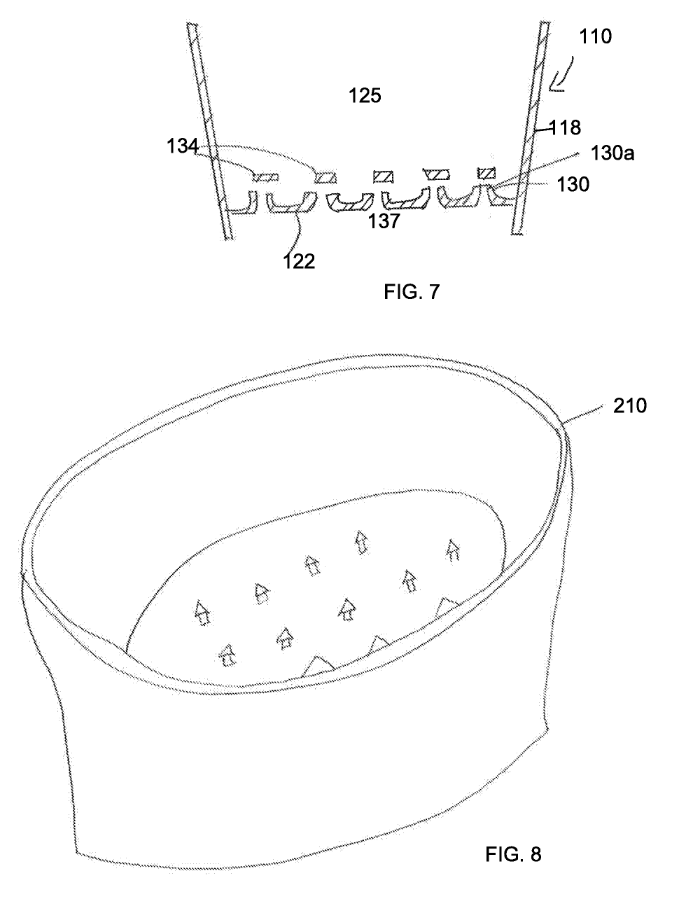

In some configurations, the conduit 30 may also be provided with one or more openings 40. The openings 40 may be provided in the sides of the conduit 30, such that air flowing through the conduit 30 may exit the side of the conduit, but debris falling downwardly may not enter the conduit 30. Thus, for example, as shown in FIG. 7, the top of the conduit may be closed.

FIG. 5 also shows arrows 44 that may indicate the direction of air flow through the conduits 30. For example, air may flow up from the openings 28 in the base 22, up through conduit 30, outwardly through holes 40 or upwardly through the top end 30a of the conduit, strike the underside of cap 34, and be displaced outwardly.

The drying stand 10 may be constructed of any suitable material. In some configurations, the drying stand 10 is constructed of a plastic material, or other material which is generally water-resistant. The drying stand may also be constructed of wood, etc., and may be treated with a water-resistant coating or stain. Similarly, the drying stand 10 may be constructed in several different ways. By way of illustration and not of limitation, some examples of construction will be provided herein. One with skill in the art will appreciate that other methods for constructing the drying stand 10 are possible. According to one example, the drying stand may be constructed of by injection molding. In some constructions, the drying stand may be formed of a single piece of material, such that the housing, base, conduits, and caps are formed integrally. In other constructions, the conduits may be inserted or connected to the plurality of openings in the base, and the caps may be connected to the conduits.

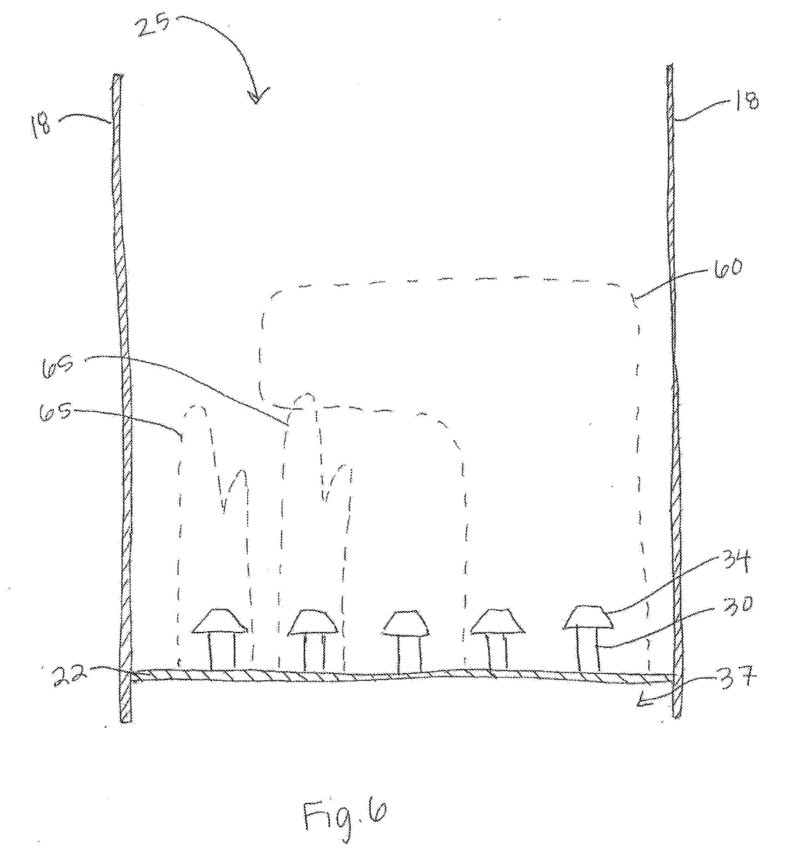

In use, a drying stand 10 may first be placed over (or, if the drying stand is configured to be placed within, then within) a heating register or vent. Next, clothing articles, etc, may be placed within the chamber 25 of the housing 13. FIG. 6 shows a side view of some footwear 60 and gloves 65 (shown in dashed lines) placed in a chamber 25. The articles may be placed in any position desired. Placing the articles over conduits 30, such that conduits 30 extend into the inside of the articles as shown in FIG. 6, may provide faster drying times as the heat is directed to the inside of the articles. In other situations, the articles to be dried may simply be placed on top of the conduits and caps 30/34 and allowed to dry. Any water or dirt falling from the articles is collected and then dumped out after the articles are dry.

One with skill in the art will appreciate that while the drying stand may be used in connection with a heat source, the drying rack may also be used to dry with just air, and a heat source is not necessary to dry the clothing in conjunction with the disclosure herein.

Turning now to FIG. 7, there is shown an alternate configuration of a drying stand 110. The basic parts are similar to those discussed with respect to FIGS. 1-6 and are thus provided the same numbering plus 100. The drying stand 110 has angled sidewalls 118 to provide a larger upper compartment 125. The base 122 is also molded to form the conduits 130. For example, the molded material may be pressed into the base 122 and the ends of the upper ends 130a of conduits 130 may be closed, and holes formed in the conduits below the upper ends to allow air flow while the closed upper ends prevent mud and water from passing the base 122.

While the entire unit may be drying stand 110 may be formed from a single piece, the base 122 can be formed separately and snapped or friction fit into plate in the sidewall 118.

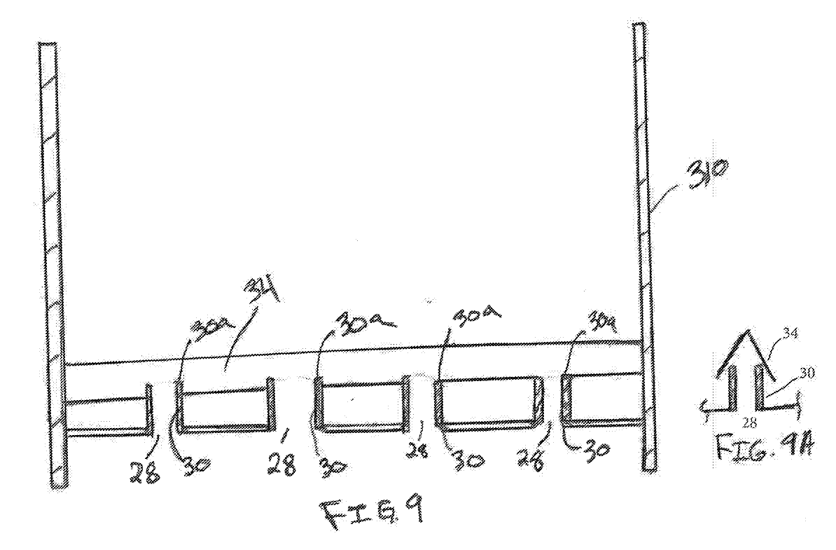

FIG. 8 shows an alternate configuration of a clothing drying stand. While the drying stand of the present invention may be generally square or rectangular, there is no limit on the shape. Thus, for example, the drying stand 210 may be oval or may have an exterior which gives a decorative look. A cover may also be included so that the stand 210 can be left in place and use for holding items, etc.

FIG. 9 shown an alternate configuration of a clothes drying stand. Rather than using conduits with individual caps, the clothes drying stand 310 has a plurality of openings 28 in the base 22 connected to conduits 30 which are in alignment so that a single cap 34 is used to cover the top end 30a of multiple conduits. Such a configuration helps to more evenly spread the air and adds additional support to the conduits. FIG. 9A shows an end view of a conduit 30 and cap 34.

There is thus disclosed an improved clothing drying stand. It will be appreciated that numerous changes may be made to the present invention without departing from the scope of the claims. The appended claims are intended to cover such modifications.

1. A drying stand, the drying stand comprising:
a housing, the housing having an outer wall and a base;
the base comprising at least one opening and at least one conduit upwardly from the at least one opening; and
wherein the outer wall extends upwardly from the base beyond the at least one opening so as to form a chamber above the base.

2. The drying stand of claim 1, wherein the at least one conduit has an open bottom end and an open upper end, and further comprising a cap at least partially covering the opening in the upper end of the at least one conduit so as to divert airflow exiting the open upper end.

3. The drying stand of claim 2, wherein the cap forms an inverted V-shape.

4. The drying stand of claim 2, wherein the cap is frusto-conical

5. The drying stand of claim 1, wherein the cap is attached to the at least one conduit.

6. The drying stand of claim 5, wherein the conduit has a height of at least 0.5 inches.

7. The drying stand of claim 1, wherein the outer wall extends below the base, defining an air gap below the base.

8. The drying stand of claim 1, wherein the housing is sized to rest over a register of a floor duct.

9. The drying stand of claim 1, wherein the housing is sized to fit inside a home heating vent.

10. The drying stand of claim 1, wherein the at least one opening comprises a plurality of openings and the at least one conduit being a plurality of conduits, each of the plurality of openings being disposed in communication with a respective one of the plurality of conduits so that a plurality of conduits extend from the base.

11. The drying stand of claim 1, wherein each of the plurality of conduits have a cap disposed thereon.

12. The drying stand of claim 7, wherein the housing has a length of between about 11 inches and about 24 inches.

13. The drying stand of claim 1, wherein the cap is integral to the at least one conduit.

14. A drying stand for drying articles of clothing and footwear, the drying stand comprising:
a housing, the housing having an outer wall and a base, the housing defining a chamber for receiving the articles of clothing and footwear;
the base having a plurality of openings for receiving hot air, wherein each of the plurality of openings has a hollow conduit extending upwardly therefrom, and each of the hollow conduits has an opening for allowing air to pass out of the conduit and a cap disposed above the opening.

15. The drying stand of claim 13, wherein the cap has a bottom side, and wherein the hollow conduit is connected to the bottom side of the cap such that a substantially open space is created between the conduit and the bottom side of the cap.

16. The drying stand of claim 13, wherein the conduit includes one or more openings therein for directing the hot air outwardly.

17. The drying stand of claim 13, wherein the outer wall extends downwardly from the base, forming an air gap.

18. A method for drying one or more clothing articles or footwear, the method comprising:
selecting a drying stand, the drying stand comprising:
a housing, the housing having an outer wall and a base, the housing defining a chamber for receiving the clothing articles and footwear;
the base having a plurality of openings for receiving hot air, wherein each of the plurality of openings has a hollow conduit extending therefrom, and each of the hollow conduits has a cap disposed at an upper end thereof for directing dripping water way from an interior of the hollow conduit;
placing the drying stand over a source of hot air; and
placing the one or more articles of clothing or footwear in the chamber.

19. The method of claim 18, wherein the method further comprises the step of placing the one or more articles of clothing or footwear in the chamber such that an inside surface of the one or more articles of clothing or footwear covers one or more of the hollow conduits.

20. The method of claim 18, wherein the step of placing the drying stand over a source of hot air includes placing the drying stand over a floor register of a forced hot air heating system.

21. The method of claim 18, wherein the step of placing the drying stand over a source of hot air includes placing the drying stand in a duct of a forced hot air heating system.
